(19) United States
(12) Patent Application Publication
(10) Pub. No.: US 2026/0312283 A1
(43) Pub. Date: Oct. 8, 2026

(54) ANTENNA DEVICE

(71) Applicant: LG INNOTEK CO.,LTD., Seoul (KR)

(72) Inventor: Sung Jin HAN, Seoul (KR)

(21) Appl. No.: 19/483,854

(22) PCT Filed: May 24, 2024
(86) PCT No.: PCT/KR2024/007043

§ 371 Date: Nov. 12, 2025

(30) Foreign Application Priority Data
May 24, 2023 (KR) 10-2023-0066938

(51) Int. Cl. H01Q 1/52; H01Q 5/20; H01Q 5/30

(52) U.S. Cl. CPC H01Q 1/521; H01Q 5/20; H01Q 5/30

(57) ABSTRACT

According to an embodiment, an antenna device is provided. The antenna device comprises: a substrate; a first antenna disposed on a first side surface of the substrate and configured to radiate a signal of a first frequency band; a second antenna disposed on a second side surface of the substrate adjacent to one side surface of the substrate and configured to radiate a signal of a second frequency band at least partially overlapping the first frequency band; and a third antenna disposed between the first antenna and the second antenna, configured to radiate a signal of a third frequency band lower than the first frequency band and the second frequency band, and preventing interference between signals radiated from the first antenna and the second antenna.

### TECHNICAL FIELD

An embodiment of the present invention relates to an antenna device applicable to an electronic product having a communication function.

### BACKGROUND ART

An electronic product having a communication function is formed to have an antenna device for transmitting/receiving electromagnetic waves. Such an antenna device operates in its characteristic resonant frequency band to transmit/receive electromagnetic waves.

An antenna device has a conducting wire with an electrical length of λ/2 relative to a wavelength A corresponding to a resonant frequency band. Such an antenna device transmits electromagnetic waves through the conducting wire, and since the electromagnetic waves become standing waves on the conducting wire, resonance occurs in the antenna device.

In a recently developed electronic product, many antennas are disposed on a substrate to perform various functions. Each of the antennas operates at its characteristic operating frequency to transmit/receive a signal.

When such multiple antennas operate in mutually different operating frequency bands, no inter-signal interference occurs, but some of the antennas use the same communication scheme. Alternatively, some of the antennas may operate in the same operating frequency band or partially overlapping frequency bands.

Thus, when operating frequency bands are identical or overlapping, there is a problem that signal interference between antennas occurs and communication quality is degraded. In order to prevent this, a method of securing isolation performance by arranging antennas to be disposed physically apart from each other or arranging a separate isolation element is applied, but this is problematic because it increases the sizes of a substrate and a device.

### DETAILED DESCRIPTION OF INVENTION

### Technical Problem

A technical object to be achieved by the present invention is directed to providing an antenna device capable of improving isolation performance as well as reducing the sizes of a substrate and an electronic product.

### Technical Solution

According to an embodiment, an antenna device is provided including: a substrate; a first antenna disposed on a first side surface of the substrate and configured to radiate a signal in a first frequency band; a second antenna disposed on a second side surface of the substrate adjacent to one side surface of the substrate and configured to radiate a signal in a second frequency band overlapping at least a portion of the first frequency band; and a third antenna that is disposed between the first antenna and the second antenna, radiates a signal in a third frequency band lower than the first frequency band and the second frequency band, and prevents interference between signals radiated from the first antenna and the second antenna.

At least a portion of the third antenna may be disposed in an area in which a signal radiation area of the first antenna and a signal radiation area of the second antenna overlap.

The first frequency band and the second frequency band may range from 2400 MHz to 2485 MHz, and the third frequency band may range from 902 MHz to 928 MHz.

The third antenna may include: a first extension portion extending in a longitudinal direction of the first side surface of the substrate; a bridge portion bent and formed from the first extension portion in a longitudinal direction of the second side surface; and a second extension portion extending from the bridge portion to be parallel to the first extension portion in the longitudinal direction of the first side surface of the substrate.

A first distance between a virtual extension line formed by extending the first extension portion in the longitudinal direction of the first side surface of the substrate and a terminal end of the first antenna and a second distance between a virtual extension line formed by extending the second extension portion in the longitudinal direction of the first side surface of the substrate and a terminal end of the second antenna may be identical within a predetermined error range.

The first distance and the second distance may be 5 mm.

The antenna device may further include a fourth antenna that is disposed on the second side surface of the substrate and radiates a signal in the second frequency band.

A terminal end of the fourth antenna may be disposed to have an orientation opposite to an orientation of the terminal end of the second antenna.

The terminal end of the first antenna and the terminal end of the second antenna may be disposed to have the same orientation.

A terminal end of the third antenna may be disposed to have an orientation orthogonal to an orientation of the terminal end of the first antenna.

### Advantageous Effects

An antenna device according to an embodiment can improve isolation performance.

Also, communication performance can be improved.

Also, the sizes of a substrate and an electronic product can be reduced.

### DESCRIPTION OF DRAWINGS

FIG. 1 is a top view illustrating an antenna device according to an embodiment of the present invention.

FIG. 2 is a top view illustrating an example of a first antenna according to an embodiment.

FIG. 3 is a graph for describing the operating performance of the first antenna of FIG. 2.

FIG. 4 is an image illustrating a radiation pattern of the first antenna of FIG. 2.

FIG. 5 is a view for describing a detailed configuration of an antenna device according to an embodiment.

FIG. 6(a) to (c) is a view for describing the signal radiation area of each antenna of the antenna device according to the embodiment.

FIG. 7 is experimental data for describing the isolation feature of the antenna device according to the embodiment.

FIGS. 8A to 9B are experimental data for describing the radiation efficiency of the antenna device according to the embodiment.

### MODES OF THE INVENTION

Hereinafter, exemplary embodiments of the present invention will be described in detail with reference to the accompanying drawings.

However, the technical spirit of the present invention is not limited to the embodiments described herein and may be implemented in various different forms. One or more of the constituent elements in the embodiments may be selectively combined and substituted for use within the scope of the technical spirit of the present invention.

In addition, unless otherwise specifically and explicitly defined and stated, terms (including technical and scientific terms) used in describing the embodiments of the present invention may be construed as having the meanings that may be commonly understood by a person with ordinary skill in the art to which the present invention pertains. The meanings of the commonly used terms such as the terms defined in dictionaries may be interpreted in consideration of the contextual meanings of the related technology.

Furthermore, the terms used in the embodiments of the present invention are for explaining the embodiments, not for limiting the present invention.

In the present specification, unless otherwise expressly stated, a singular form may also include a plural form, and the expression “at least one (or one or more) of A, B, and C” may include one or more of all possible combinations made from A, B, and C.

Furthermore, terms such as “first,” “second,” “A,” “B,” “(a),” and “(b)” may be used to describe constituent elements of the exemplary embodiments of the present invention.

These terms are used merely to distinguish one constituent element from another constituent element, and the nature, sequence, or order of such constituent elements is not limited by the terms.

Furthermore, when one constituent element is described as being “linked,” “coupled,” or “connected” to another constituent element, the former may be directly “linked,” “coupled,” or “connected” to the latter, or may be indirectly “linked,” “coupled,” or “connected” to the latter through yet another constituent element disposed therebetween.

In addition, when one constituent element is described as being formed or disposed “above (on)” or “below (under)” another constituent element, it includes not only a case in which the two constituent elements are in direct contact with each other, but also a case in which one or more other constituent elements are formed or disposed between the two constituent elements. In addition, the expression “above (on)” or “below (under)” may mean a downward direction as well as an upward direction relative to one constituent element.

Hereinafter, embodiments will be described in detail with reference to the accompanying drawings, in which the same reference numerals are used for the same or corresponding constituent elements throughout the drawings, and redundant descriptions of such constituent elements will be omitted.

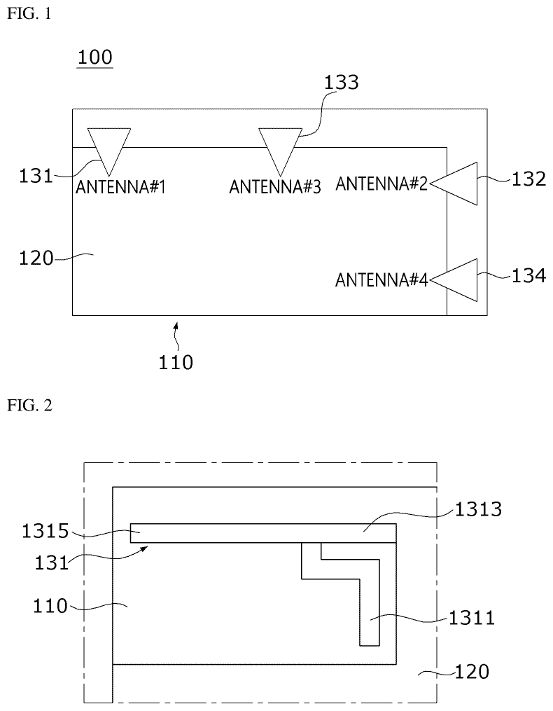

FIG. 1 is a top view illustrating an antenna device according to an embodiment of the present invention.

Referring to FIG. 1, an antenna device 100 of this embodiment may include a substrate 110, a ground body 120, first to fourth antennas 131 to 134, and an isolation element 140.

The substrate 110 may be provided for feeding and support in the antenna device 100. The substrate 110 may have a flat structure. The substrate 110 may be a printed circuit board (PCB). Here, the substrate 110 may be implemented as a single substrate or implemented by stacking a plurality of substrates. In addition, transmission lines (not shown) may be embedded in the substrate 110. Each transmission line may be connected to a control module (not shown) through one end portion. In addition, each transmission line may be exposed through the other end portion. That is, each transmission line may receive a signal from the control module and transmit the signal from one end portion to the other end portion.

The substrate 110 may include a dielectric. The conductivity σ of the substrate may be 0.02. In addition, the permittivity & of the substrate 110 may be 4.4. Furthermore, the loss tangent of the substrate 110 may be 0.02. Here, the transmission lines may be made of a conductive material. Here, the transmission lines may contain at least any one of silver (Ag), palladium (Pd), platinum (Pt), copper (Cu), gold (Au), and nickel (Ni).

The ground body 120 may be provided for grounding in the antenna device 100. This ground body 120 may be formed in a partial or overall area of the substrate 110. Here, the ground body 120 may be disposed apart from the transmission lines of the substrate 110. That is, the ground body 120 may not be electrically connected to any transmission line. Here, the ground body 120 may be disposed on at least any one of the lower surface or upper surface of the substrate 110. Alternatively, when the substrate 110 is provided as a plurality of substrates, the ground body 120 may be disposed between the substrates. In addition, the ground body 120 may be made of a metal material. Here, the ground body 120 may contain at least any one of silver (Ag), palladium (Pd), platinum (Pt), copper (Cu), gold (Au), and nickel (Ni).

Antennas 130 may be provided for signal transmission/reception in the antenna device 100. Here, each of the antennas 130 may operate when a signal is supplied from the substrate 110. In addition, each of the antennas 130 may operate in at least one predetermined resonant frequency band, which is called an operating frequency. Here, the operating frequencies of the antennas 130 may be identical or differ from each other. In addition, each of the antennas 130 may resonate at a predetermined impedance.

The antennas 130 may be disposed on the substrate 110. Here, the antennas 130 may be disposed apart from each other. The antennas 130 may be disposed on the upper surface of the substrate 110. The antennas 130 may be in contact with a transmission line. In addition, the antennas 130 may be in contact with the ground body 120. Furthermore, the antennas 130 may have the same shape or have different shapes. The antennas 130 may be made of a conductive material. Here, the antennas 130 may contain at least any one of silver (Ag), palladium (Pd), platinum (Pt), copper (Cu), gold (Au), and nickel (Ni).

The antennas 130 may include the first antenna 131 to the fourth antenna 134.

The isolation element 140 may be provided in the antenna device 100 to prevent signal interference between a second antenna 132 and the fourth antenna 134. The isolation element 140 may be disposed between the second antenna 132 and the fourth antenna 134. The isolation element 140 may be disposed on a second side surface of the substrate.

Alternatively, when the substrate 110 is provided as a plurality of substrates, the isolation element 140 may be disposed between the substrates. The isolation element 140 may be in contact with the ground body 120. The isolation element 140 may be made of a conductive material. For example, the isolation element 140 may contain at least any one of silver (Ag), palladium (Pd), platinum (Pt), copper (Cu), gold (Au), and nickel (Ni).

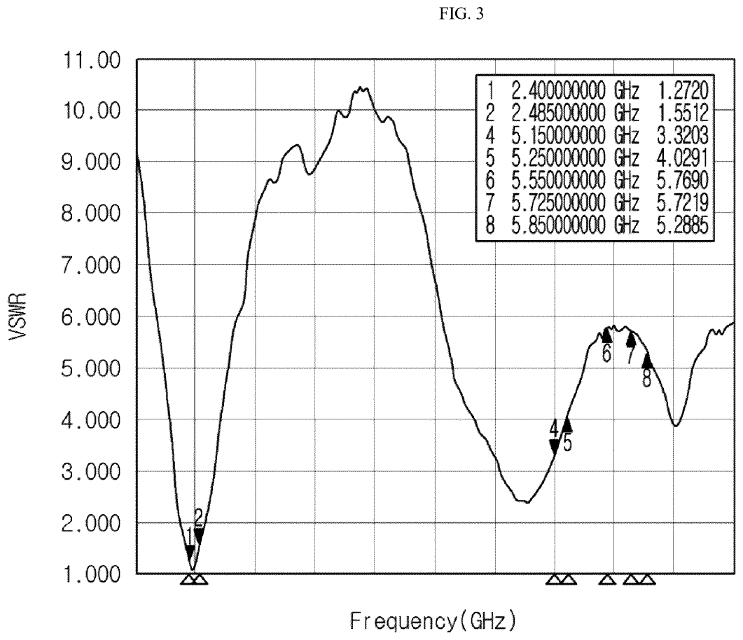

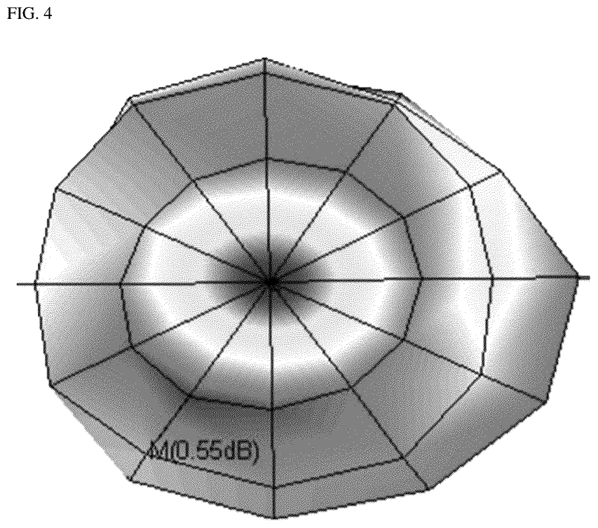

FIG. 2 is a top view illustrating an example of a first antenna according to an embodiment, and FIG. 3 is a graph for describing the operating performance of the first antenna of FIG. 2. Here, FIG. 3 shows a variation in the voltage standing wave ratio (VSWR) of the first antenna in the frequency domain. In addition, FIG. 4 is an image illustrating a radiation pattern of the first antenna of FIG. 2.

Referring to FIG. 2, each first antenna 131 according to an embodiment may include a feeding portion 1311, a ground portion 1313, and a radiator 1315.

The feeding portion 1311 may supply a signal in the first antenna 131. The feeding portion 1311 may be connected to a transmission line through one end portion. Here, the feeding portion 1311 may not be in contact with the ground body 120. The one end portion of the feeding portion 1311 may be defined as a feeding point (FP). The FP may be located close to the ground body 120 and may be in contact with the transmission line. Thus, a signal may be supplied from a control module to the feeding portion 1311. In addition, the feeding portion 1311 may extend from the FP through the other end portion. Thus, the feeding portion 1311 supplies a signal from the one end portion to the other end portion.

The ground portion 1313 may ground the first antenna 130. This ground portion 1313 may be connected to the ground body 120 through one end portion. Here, the one end portion of the ground portion 1313 may be defined as an FP. In addition, the FP may be in contact with the ground body 120. In addition, the ground portion 1313 may extend from the FP through the other end portion. In addition, the ground portion 1313 may be connected to the feeding portion 1311. Thus, the ground portion 1313 may be grounded to the ground body 120. In addition, by the ground portion 1313, a signal may be transmitted from the feeding portion 1311 toward the ground body 120.

The radiator 1315 may be provided for the actual operation of the first antenna 130. The radiator 1315 may radiate a signal in a resonant frequency band. This radiator 1315 may be connected to the feeding portion 1311 and the ground portion 1313 through one end portion. In addition, the radiator 1315 may extend from the feeding portion 1311 and the ground portion 1313 through the other end portion. The other end portion of the radiator 1315 may be open. In addition, the radiator 1315 may be formed in a bar type. Thus, a signal is supplied from the feeding portion 1311 to the radiator 1315, and the radiator 1315 may radiate the signal. Here, the size of the radiator 1315 may be determined according to the resonant frequency band. For a wavelength A corresponding to the resonant frequency band, the electrical length of the radiator 1315 may be determined to be λ/8.

According to an embodiment, the first antenna 131 may operate in a single resonant frequency band as illustrated in FIG. 3. The operating frequency band of the first antenna may be approximately 2.4 GHz. In addition, in the resonant frequency band, the radiation pattern of the antenna 130 may be formed as illustrated as in FIG. 4.

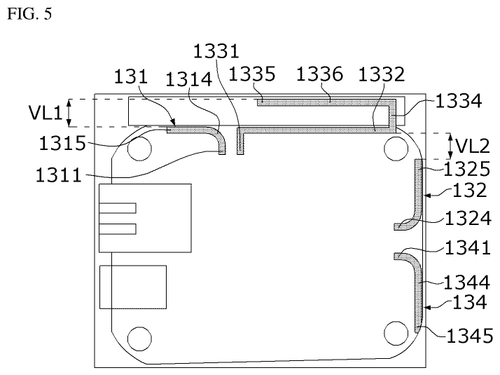

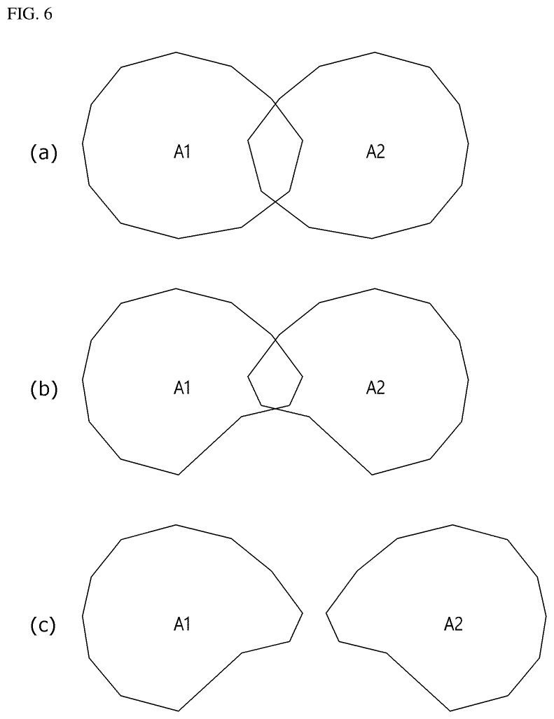

In an embodiment, similar to the above-described first antenna, each of the second antenna to the fourth antenna may be formed to include a feeding portion, a ground portion, and a radiator. However, the third antenna may have a different shape and a different operating frequency band from the remaining antennas. A detailed description related thereto will be set forth in FIG. 5 below.

FIG. 5 is a view for describing a detailed configuration of an antenna device according to an embodiment, and FIG. 6 is a view for describing the signal radiation area of each antenna of the antenna device according to the embodiment.

Referring to FIG. 5, the antenna device according to the embodiment may include a substrate and first to fourth antennas.

The substrate 110 may have a flat structure. The substrate 110 may be a PCB and have a flat structure. Transmission lines may be embedded in the substrate 110, and each of the transmission lines may be connected to a control module through one end portion. Each of the transmission lines may receive a signal from the control module and transmit the signal to each connected antenna. In the embodiment, a substrate may be formed with an X-axis length of 80 mm and a Y-axis length of 67.5 mm, but substrates of various sizes may be used depending on the use and size of an electronic product to which a substrate is applied and on the number of disposed antennas and the number of elements.

The first antenna 131 is disposed on a first side surface of the substrate 110 and radiates a signal in a first frequency band. The first antenna 131 may include the feeding portion 1311 extending from an FP that is one end and the radiator 1313 that is bent and extends from the feeding portion 1311 and is provided at the other end. A bent portion 1314 may be formed between the feeding portion 1311 and the radiator 1313 of the first antenna 131 so that the feeding portion 1311 and the radiator 1313 are oriented orthogonally to each other. The feeding portion 1311 of the first antenna may be connected to a transmission line of the substrate 110, and the radiator 1315 may be disposed to have an orientation opposite to the direction in which the second antenna 132 is located. In the embodiment, the first antenna 131 is an antenna element performing ZigBee communication and may have an operating frequency band of 2400 MHz to 2485 MHz.

The second antenna 132 is disposed on a second side surface adjacent to the first side surface of the substrate 110 and may radiate a signal in a second frequency band that overlaps at least a portion of the first frequency band. The second antenna 132 may include a feeding portion 1321 extending from an FP that is one end and a radiator 1325 that is bent and extends from the feeding portion 1321 and is provided at the other end. A bent portion 1324 may be formed between the feeding portion 1321 and the radiator 1325 of the second antenna 132 so that the feeding portion 1321 and the radiator 1325 are oriented orthogonally to each other. The feeding portion 1321 of the second antenna 132 may be connected to a transmission line of the substrate 110, and the radiator 1325 may be disposed to have an orientation opposite to a direction in which the fourth antenna 134 is located. That is, a terminal end of the second antenna 132 may be disposed to have an orientation orthogonal to an orientation of a terminal end of the first antenna 131. In the embodiment, the second antenna 132 is an antenna element performing Wi-Fi communication and may have an operating frequency band of 2400 MHz to 2485 MHz.

The third antenna 133 is disposed between the first antenna 131 and the second antenna 132, may radiate a signal in a third frequency band that is lower than the first frequency band and the second frequency band, and may prevent interference between signals radiated from the first antenna 131 and the second antenna 132. The third antenna 133 may include a first extension portion 1332 extending in a longitudinal direction of the first side surface of the substrate 100, a bridge portion bent and formed from the first extension portion 1332 in a longitudinal direction of the second side surface, and a second extension portion 1336 extending from the bridge portion 1334 to be parallel to the first extension portion 1332 in the longitudinal direction of the first side surface of the substrate 100. The first extension portion 1332 is connected to the feeding portion 1331 at one end, extends in the longitudinal direction of the first side surface of the substrate 100, and may be connected to the bridge portion 1334 at the other end. The bridge portion 1334 extends in a direction orthogonal to the first extension portion 1332, may be connected to the first extension portion 1332 at one end, and may be connected to the second extension portion 1336 at the other end. The second extension portion 1336 is formed to extend in the longitudinal direction of the first side surface of the substrate 100, may be connected to the bridge portion 1334 at one end, and may be provided with the radiator 1335 at the other end. The radiator 1335 of the third antenna 133 may be oriented in the same direction as the radiator 1313 of the first antenna 131. That is, the terminal end of the first antenna 131 and a terminal end of the third antenna 133 may be disposed to have the same orientation.

Unlike the embodiment, the terminal end of the first antenna 131 and the terminal end of the third antenna 133 may be disposed to have opposite orientations. That is, the third antenna 133 has an operating frequency capable of preventing signal interference between the first antenna 131 and the second antenna 132, is designed with a sufficient length, and thus may serve as an isolation element, and the orientation of a radiator may vary according to a design environment.

The third antenna 133 may radiate a signal in an operating frequency band that is lower than the first frequency band and the second frequency band. The length of an antenna may be determined according to a radio frequency in use. The length of an antenna may be determined according to the wavelength 2 of radio waves, and the wavelength of the radio waves is inversely proportional to an operating frequency in use. Accordingly, the length of an antenna may be determined according to a frequency in use. That is, the length of an antenna is determined according to a radio frequency in use, and the higher the radio frequency, the shorter the length of the antenna, and the lower the frequency, the longer the length of the antenna may be. Accordingly, in the embodiment, as the operating frequency of each antenna becomes lower, the wavelength becomes longer, and thus the length of the antenna should be made longer.

The length of an antenna may be designed to optimize the antenna's efficiency and impedance matching. A minimum length of an antenna enabling transmission/reception of a signal is λ/4, and a length of the antenna for optimal transmission/reception of a signal may be determined to be λ/2.

Accordingly, the length of an antenna for optimal signal transmission/reception may be determined according to Equation 1 below.

$$L = \frac{λ}{2} = \frac{c}{2 f} \qquad [ Equation 1 ]$$

In Equation 1, L is the length of an antenna for optimal signal transmission/reception, c is the speed of light, and f is an operating frequency of the antenna. Accordingly, the third antenna may be designed and disposed to be about 2.6 times longer than the first antenna and the second antenna according to an operating frequency.

The third antenna 133 is designed and disposed to be longer than the first antenna 131 and the second antenna 132 and thus may sufficiently serve as an isolator capable of preventing signal interference between the first antenna 131 and the second antenna 132. That is, when the operating frequency of the third antenna 133 is designed to be sufficiently lower than the operating frequencies of the first antenna 131 and the second antenna 132, the third antenna 133 may be designed and disposed to be long between the first antenna 131 and the second antenna 132, and thus signal interference between the first antenna 131 and the second antenna 132 may be efficiently prevented. To this end, in the embodiment, the operating frequencies of the first antenna 131 and the second antenna 132 may be set to be at least twice as high as the operating frequency of the third antenna 133.

The operating frequency features of the first to fourth antennas 131 to 134 according to the embodiment may be summarized as in Table 1 below.

TABLE 1

| | Communication | Operating |
|---|---|---|
| Antenna | scheme | frequency (MHz) |
| First antenna | ZigBee | 2400~2485 |
| Second antenna | Wi-Fi | 2400~2485 |
| Third antenna | Z-Wave | 902~928 |
| Fourth antenna | Wi-Fi | 2400~2485 |

A first distance L1 between a virtual extension line VL1 formed by extending the first extension portion 1332 of the third antenna 133 in the longitudinal direction of the first side surface of the substrate 100 and the terminal end of the first antenna 131 may be equal to a second distance L2 between a virtual extension line VL2 formed by extending the second extension portion 1336 in the longitudinal direction of the first side surface of the substrate 100 and the terminal end of the second antenna 132 within a predetermined error range. The first distance L1 may be a minimum straight distance between the virtual extension line VL1 formed by extending the radiator 1335 of the third antenna 133 in the longitudinal direction of the first side surface, specifically, in an X-axis direction in which the first antenna 131 is located, and the radiator 1315 of the first antenna 131.

In addition, the second distance L2 may be a minimum straight distance between the virtual extension line VL2 formed by extending the second extension portion 1336 of the third antenna 133 in the longitudinal direction of the first side surface, specifically, in an X-axis direction in which the second antenna 132 is located, and the radiator 1325 of the second antenna 132.

The first distance L1 and the second distance L2 may be equal within the predetermined error range, and for example, the first distance L1 and the second distance L2 may be 5 mm. Through this arrangement, signal interference between the first antenna 131 and the second antenna 132 may be minimized in consideration of the operating frequencies of the first to third antennas 131 to 133, the lengths of the antennas, and the size of the substrate.

FIG. 6 is a view illustrating the signal radiation area of a first antenna and the signal radiation area of a second antenna to describe the isolation performance of a third antenna.

Referring to FIG. 6A, when the third antenna is not disposed, the signal radiation area A1 of the first antenna and the signal radiation area λ/2 of the second antenna substantially overlap, and thus the occurrence of signal interference may be identified. Referring to FIG. 6B, when the third antenna is disposed in a straight line, the signal radiation area A1 of the first antenna and the signal radiation area λ/2 of the second antenna partially overlap, and thus the occurrence of signal interference may be identified. Referring to FIG. 6C, when the third antenna is disposed in the form according to the embodiment, the signal radiation area A1 of the first antenna and the signal radiation area λ/2 of the second antenna are prevented from overlapping, and thus the non-occurrence of signal interference may be confirmed. That is, the operating frequencies of the first antenna and the second antenna are designed to be at least twice as high as the operating frequency of the third antenna, the third antenna is disposed to have a sufficient length between the first antenna and the second antenna, and thus signal interference between the first antenna and the second antenna may be effectively prevented.

When the third antenna is not disposed, the signal radiation area of the first antenna and the signal radiation area of the second antenna significantly overlap, and thus the occurrence of signal interference may be identified.

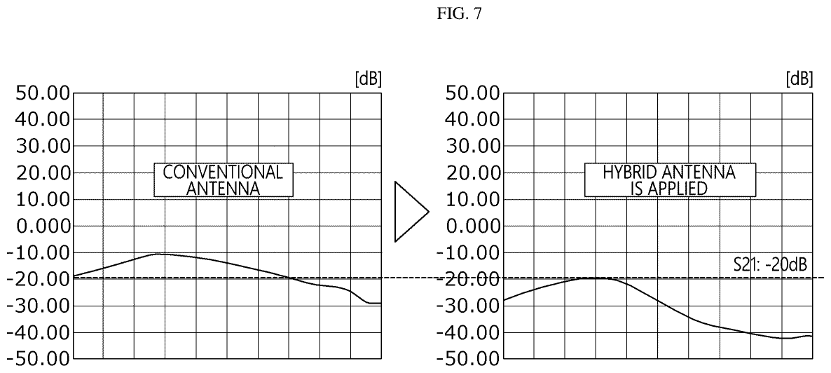

FIG. 7 is experimental data for describing the isolation feature of the antenna device according to the embodiment.

Compared with the case in which the third antenna is disposed in a straight line as in FIG. 7A, it may be confirmed from FIG. 7B that when the third antenna is disposed according to the embodiment, the isolation performance is improved by about 10 dB or more, from −10 dB to −20 dB.

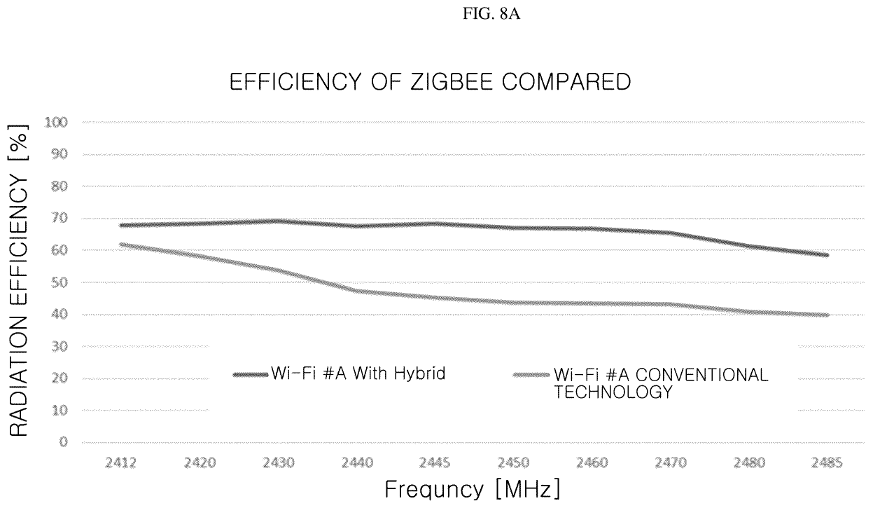

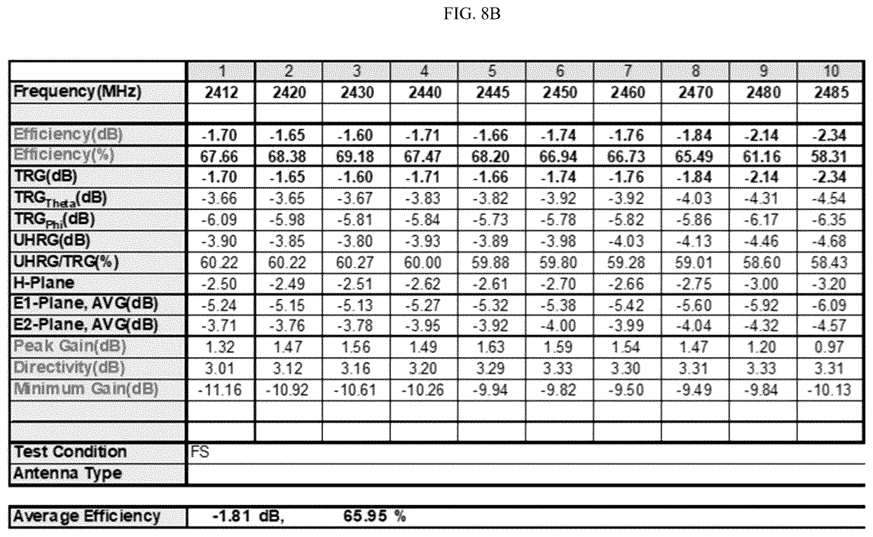

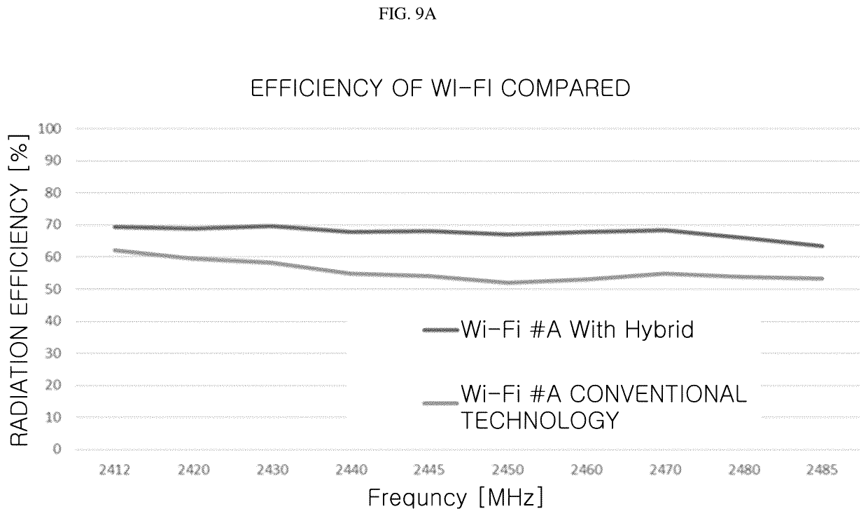

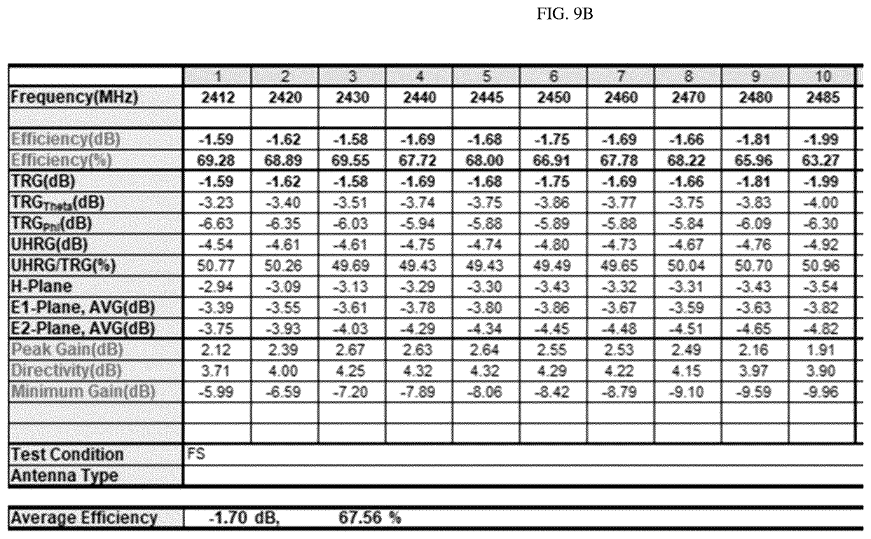

FIGS. 8 and 9 are experimental data for describing the radiation efficiency of the antenna device according to the embodiment.

Referring to FIGS. 8A and 8B, it may be confirmed that the radiation efficiency of a ZigBee antenna that is the first antenna improves by about 8% to about 25% in its operating frequency band.

Referring to FIGS. 9A and 9B, it may be confirmed that the radiation efficiency of a Wi-Fi antenna that is the third antenna improves by about 9% to about 18% in its operating frequency band.

This improvement in isolation performance and radiation efficiency is attributable to the effect whereby the third antenna reflects electromagnetic signals radiated from the first antenna and the second antenna to form maximum directivity in the opposite direction, thereby canceling inter-antenna interference.

Referring to FIG. 5 again, the fourth antenna 134 is disposed on a second side surface of the substrate 110 and may radiate a signal in a second frequency band. The fourth antenna 134 may include a feeding portion 1341 extending from an FP that is one end and a radiator 1345 that is bent and extends from the feeding portion 1341 and is provided at the other end. A bent portion 1344 may be formed between the feeding portion 1341 and the radiator 1345 of the fourth antenna 134 so that the feeding portion 1341 and the radiator 1345 are oriented orthogonally to each other. The feeding portion 1341 of the fourth antenna 134 may be connected to a transmission line of the substrate 100, and the radiator 1345 may be disposed to have an orientation opposite to a direction in which the second antenna 132 is located. That is, a terminal end of the fourth antenna 134 may be disposed to have an orientation opposite to an orientation of the terminal end of the second antenna 132. In the embodiment, the fourth antenna 134 is an antenna element performing ZigBee communication and may have an operating frequency band of 2400 MHz to 2485 MHz.

The isolation element 140 may be disposed between the second antenna 132 and the fourth antenna 134. The isolation element may be provided to prevent signal interference between the second antenna 132 and the fourth antenna 134. The isolation element 140 may be disposed on the second side surface of the substrate 100 and may be disposed between the feeding portion 1321 and the bent portion 1324 of the second antenna 132 and the feeding portion 1341 and the bent portion 1344 of the fourth antenna 134.

The term “~unit” used in the embodiment means software or hardware components such as a field-programmable gate array (FPGA) or an application specific integrated circuit (ASIC), and the “unit” performs certain functions. However, the “~unit” is not limited to software or hardware. A “~unit’ may be configured to reside on an addressable storage medium and may also be configured to reproduce one or more processors. Accordingly, for example, a “~unit” includes components such as software components, object oriented software components, class components, and task components and processors, functions, attributes, procedures, subroutines, segments of program code, drivers, firmware, microcode, circuits, data, databases, data structures, tables, arrays, and variables. The functions provided in the components and “~units” may be combined into a smaller number of components and “~units” or may be further separated into additional components and “~units.” In addition, the components and “~units” may also be implemented to reproduce one or more CPUs within a device or a security multimedia card.

While the present invention has been described above with reference to exemplary embodiments, those skilled in the art will understand that various modifications and variations may be made to the present invention without departing from the scope and spirit of the present invention.

1. An antenna device comprising:
a substrate;
a first antenna disposed on a first side surface of the substrate and configured to radiate a signal in a first frequency band;
a second antenna disposed on a second side surface of the substrate adjacent to one side surface of the substrate and configured to radiate a signal in a second frequency band overlapping at least a portion of the first frequency band; and
a third antenna that is disposed between the first antenna and the second antenna, radiates a signal in a third frequency band lower than the first frequency band and the second frequency band, and prevents interference between signals radiated from the first antenna and the second antenna.

2. The antenna device of claim 1, wherein at least a portion of the third antenna is disposed in an area in which a signal radiation area of the first antenna and a signal radiation area of the second antenna overlap.

3. The antenna device of claim 1, wherein the first frequency band and the second frequency band range from 2400 MHz to 2485 MHz, and the third frequency band ranges from 902 MHz to 928 MHz.

4. The antenna device of claim 1, wherein the third antenna includes:
a first extension portion extending in a longitudinal direction of the first side surface of the substrate;
a bridge portion bent and formed from the first extension portion in a longitudinal direction of the second side surface; and
a second extension portion extending from the bridge portion to be parallel to the first extension portion in the longitudinal direction of the first side surface of the substrate.

5. The antenna device of claim 4, wherein a first distance between a virtual extension line formed by extending the first extension portion in the longitudinal direction of the first side surface of the substrate and a terminal end of the first antenna is equal to a second distance between a virtual extension line formed by extending the second extension portion in the longitudinal direction of the first side surface of the substrate and a terminal end of the second antenna within a predetermined error range.

6. The antenna device of claim 5, wherein the first distance and the second distance are 5 mm.

7. The antenna device of claim 1, further comprising a fourth antenna that is disposed on the second side surface of the substrate and radiates a signal in the second frequency band.

8. The antenna device of claim 7, wherein a terminal end of the fourth antenna is disposed to have an orientation opposite to an orientation of a terminal end of the second antenna.

9. The antenna device of claim 1, wherein a terminal end of the first antenna and a terminal end of the third antenna are disposed to have the same orientation.

10. The antenna device of claim 9, wherein a terminal end of the second antenna is disposed to have an orientation orthogonal to an orientation of the terminal end of the first antenna.

11. The antenna device of claim 1, wherein a center frequency of the first frequency band and a center frequency of the second frequency band are each at least twice a center frequency of the third frequency band.

12. The antenna device of claim 1, wherein a length of the third antenna is at least twice an electrical length of the first antenna or the second antenna.

13. The antenna device of claim 1, wherein the first antenna includes:
a feeding portion extending from a feeding point;
a radiator forming a terminal end; and
a bent portion that connects the feeding portion and the radiator and is formed to enable the feeding portion to have an orientation orthogonal to an orientation of the radiator.

14. The antenna device of claim 1, wherein the third antenna reflects electromagnetic waves from the first antenna and the second antenna to cancel interference.

15. The antenna device of claim 7, wherein a terminal end of the first antenna and a terminal end of the third antenna have the same orientation,
a terminal end of the second antenna has an orientation orthogonal to the orientation of the terminal end of the first antenna, and
a terminal end of the fourth antenna has an orientation opposite to the orientation of the terminal end of the second antenna.

16. The antenna device of claim 7, further comprising an isolation element that is disposed between the second antenna and the fourth antenna to prevent signal interference.

17. The antenna device of claim 4, wherein the first extension portion and the second extension portion of the third antenna are disposed parallel to the first side surface of the substrate, and the bridge portion is disposed parallel to the second side surface of the substrate.

18. The antenna device of claim 1, wherein the first antenna, the second antenna, and the third antenna are formed of one conductive material selected from the group consisting of silver (Ag), palladium (Pd), platinum (Pt), copper (Cu), gold (Au), and nickel (Ni).

19. The antenna device of claim 4, wherein a total length of the third antenna, which extends from one end of the first extension portion connected to a feeding portion to the other end of the second extension portion provided with a radiator, is one-half of a wavelength (λ) corresponding to the third frequency band.

20. The antenna device of claim 1, wherein the first antenna is an antenna for ZigBee communication,
the second antenna is an antenna for Wi-Fi communication, and
the third antenna is an antenna for Z-Wave communication.
